(19) United States
(12) Patent Application Publication
(10) Pub. No.: US 2013/0196230 A1
(43) Pub. Date: Aug. 1, 2013

(54) COATING SOLUTION, ELECTRIC COLLECTOR, AND METHOD FOR PRODUCING ELECTRIC COLLECTOR

(71) Applicants: Hitoshi Yokouchi, Minato-ku (JP); Masahiro Ohmori, Minato-ku (JP); Akifumi Takeda, Minato-ku (JP)

(72) Inventors: Hitoshi Yokouchi, Minato-ku (JP); Masahiro Ohmori, Minato-ku (JP); Akifumi Takeda, Minato-ku (JP)

(73) Assignee: SHOWA DENKO K.K., Tokyo (JP)

(21) Appl. No.: 13/806,955

(22) PCT Filed: Sep. 2, 2011
(86) PCT No.: PCT/JP2011/004946

§ 371 Date: Apr. 15, 2013

(30) Foreign Application Priority Data
Sep. 2, 2010 (JP) 2010-197006
Sep. 2, 2010 (JP) 2010-197007

(51) Int. Cl. H01M 4/66; H01G 11/68

(52) U.S. Cl. CPC H01M 4/667; H01G 11/68
USPC 429/211; 361/502; 252/500; 252/510; 427/58

(57) ABSTRACT

A coating solution comprising (A) water or a mixed solvent of water and an organic solvent, (B) an electrical conducting material, and (C) at least one selected from the group consisting of polysaccharides and polysaccharide derivatives as essential components, and (D) at least one selected from the group consisting of a polybasic organic acid and a polybasic organic acid derivative as an optional component, wherein mass W_{B} of the component (B), mass W_{C} of the component (C) and mass W_{D} of the component (D) satisfy a relationship of 0.5≦W_{B}/(W_{C}+W_{D})≦5. An electric collector comprising an electrically-conductive substrate, and an undercoat layer formed on one or both surfaces of the electrically-conductive substrate, wherein the undercoat layer is formed by applying a coating solution comprising (A) water or a mixed solvent of water and an organic solvent, and (B) an electrical conducting material, and the electric collector is 100 milliohm or less in a penetration resistance value measured at 25 deg C.

### TECHNICAL FIELD

The present invention relates to a coating solution, an electric collector and a method for producing an electric collector. More particularly, the present invention relates to a coating solution for the production of an electric collector of electrochemical devices such as a secondary battery and an electric double-layer capacitor, solar batteries, touch panels and the like.

### BACKGROUND ART

There have been known, as an electrochemical device, secondary batteries such as a lithium ion secondary battery and a nickel-hydrogen battery; and capacitors such as an electric double-layer capacitor and a hybrid capacitor.

An electrode of the electrochemical device is commonly made by laminating an electric collector composed of an electrically-conductive substrate and an electrode active material layer comprising an active material or the like. There is proposed an electric collector constituted by laminating an electrically-conductive substrate and an undercoat layer so as to decrease internal resistance or impedance of a secondary battery or a capacitor. The undercoat layer is usually formed by applying a coating solution comprising an electrically-conductive substance and a solvent on an electrically-conductive substrate, and drying the coating solution.

By the way, it is said that a film obtained from a coating solution comprising polysaccharides such as chitosan has high ion permeability or high ion mobility, and is therefore capable of decreasing internal resistance or impedance of a lithium ion secondary battery or an electric double-layer capacitor (PLT4).

Thus, PLT 1 describes, as a coating solution for forming an undercoat layer, for example, an under-coating material comprising an aprotic polar solvent such as N-methyl-2-pyrrolidone, a hydroxyalkyl chitosan such as glycerylated chitosan, an organic acid such as trimellitic acid and/or a derivative thereof, and an electrically-conductive substance such as acetylene black (see Table 6). PLT 2 describes an undercoating material comprising a polar solvent such as N-methyl-2-pyrrolidone, a hydroxyl group-containing resin such as cyanoethylated pullulan, an organic acid such as pyromellitic acid or a derivative thereof, and an electrically-conductive substance such as acetylene black (see Table IV-6). PLT 3 describes a paste comprising an ion-permeable compound obtained by crosslinking chitosan, chitin or the like with pyromellitic anhydride or the like, an electrically-conductive carbon fine powder such as acetylene black and a solvent such as water (see Examples). An electric collector obtained from the paste described in PLT 3 can provide an electric double-layer capacitor in which impedance is moderately low and also a capacitance retention ratio at the 20th cycle is moderately high.

### CITATION LIST

### Patent Literature

[PLT 1]: JP 2008-60060 A
[PLT 2]: WO 2009/147989 A1
[PLT 3]: WO 2007/043515 A1
[PLT 4]: JP 2006-286344 A

### SUMMARY OF INVENTION

### Technical Problem

In the undercoating material described in PLT 1, a nitrogen-containing aprotic polar organic solvent such as N-methyl-2-pyrrolidone or a sulfur-containing aprotic polar organic solvent such as dimethyl sulfoxide is used. Since these aprotic polar organic solvents have a high boiling point, drying at a high temperature or drying over a long time is required for the formation of an undercoat layer, and also a drying equipment to cope with odor and toxicity of a solvent vapor is required, thus causing an increase in production costs of an electrode. Therefore, from the viewpoints of cost reduction, environmental burden reduction and the like, it is required to replace an organic solvent with an aqueous solvent.

In PLT 2, a lot of polar solvents used in the undercoating material are listed and water is exemplified as one of them. However, the solvent used specifically in the undercoating material comprising cyanoethylated pullulan, cyanoethylated cellulose or cyanoethylated dihydroxypropyloxy chitosan is an aprotic polar organic solvent such as N-methyl-2-pyrrolidone (see Table IV-2).

Thus, an object of the present invention is to provide a coating solution suited for the formation of an undercoat layer, which is capable of obtaining an electrochemical device having low internal resistance, low impedance and high capacitance retention ratio using an aqueous solvent contributable to cost reduction and environmental burden reduction, and to provide an electric collector which is capable of obtaining an electrochemical device having low internal resistance, low impedance and high α-pacitance retention ratio even when used after storage under high humidity over a long time.

### Solution to Problem

The present inventors have intensively studied so as to achieve the above objects. As a result, they have found that a penetration resistance value of an electric collector comprising an electrically-conductive substrate and an undercoat layer can be decreased when an undercoat layer is formed using a coating solution in which (A) water or a mixed solvent of water and an organic solvent is allowed to comprise (B) an electrical conducting material, (C) at least one selected from the group consisting of polysaccharides and polysaccharide derivatives and (D) at least one selected from the group consisting of a polybasic organic acid and a polybasic organic acid derivative in a specific weight ratio. They have also found that an electric collector, which includes an electrically-conductive substrate and an undercoat layer formed on one or both surfaces of the electrically-conductive substrate by applying a coating solution comprising. (A) water or a mixed solvent of water and an organic solvent and (B) an electrical conducting material, and also has a penetration resistance value measured at 25 deg C. of 100 milliohm or less, is capable of providing an electrochemical device having low internal resistance and low impedance even after storage under high humidity over a long period.

That is, the present invention includes the followings.

(1) A coating solution comprising (A) water or a mixed solvent of water and an organic solvent, (B) an electrical conducting material, and (C) at least one selected from the group consisting of polysaccharides and polysaccharide derivatives as essential components, and (D) at least one selected from the group consisting of a polybasic organic acid and a polybasic organic acid derivative as an optional component, wherein mass W_{B} of the component (B), mass W_{C} of the component (C) and mass W_{D} of the component (D) satisfy a relationship of 0.5≦W_{B}/(W_{C}+W_{D})≦5.

(2) The coating solution according to (1), wherein the component (A) is a mixed solvent comprising water and a primary or secondary monohydric alcohol having 1 to 4 carbon atoms.

(3) The coating solution according to (1) or (2), wherein the component (C) is at least one selected from the group consisting of chitin, chitosan, cellulose, cellulose derivative and chitosan derivative.

(4) The coating solution according to (1) or (2), wherein the component (C) is hydroxyalkylated polysaccharides.

(5) The coating solution according to any one of (1) to (4), wherein the component (D) is at least one selected from the group consisting of a polybasic organic acid having a valence of 3 or more and a derivative of a polybasic organic acid having a valence of 3 or more.

(6) The coating solution according to any one of (1) to (5), wherein the component (D) is at least one selected from the group consisting of an aromatic polybasic carboxylic acid and an aromatic polybasic carboxylic acid derivative.

(7) The coating solution according to any one of (1) to (6), wherein the component (D) is a polybasic organic acid anhydride.

(8) The coating solution according to any one of (1) to (7), wherein the component (B) is an electrically-conductive carbonaceous material.

(9) The coating solution according to any one of (1) to (8), wherein the mass W_{C} of the component (C) and the mass W_{D} of the component (D) satisfy a relationship of 0.8≦W_{C}/W_{D}≦5.

(10) An electric collector comprising an electrically-conductive substrate, and an undercoat layer formed on one or both surfaces of the electrically-conductive substrate, wherein the undercoat layer is formed by applying a coating solution comprising: (A) water or a mixed solvent of water and an organic solvent, and (B) an electrical conducting material, in which the electric collector is 100 milliohm or less in a penetration resistance value measured at 25 deg C.

(11) The electric collector according to (10), wherein the coating solution further comprises (C) a binder.

(12) The electric collector according to (11), wherein the component (C) is at least one selected from the group consisting of polysaccharides and polysaccharide derivatives.

(13) The electric collector according to (11), wherein the component (C) is at least one selected from the group consisting of chitin, chitosan, cellulose, cellulose derivative and chitosan derivative.

(14) The electric collector according to (11), wherein the component (C) is hydroxyalkylated polysaccharides.

(15) The electric collector according to (10) or (11), wherein the coating solution further comprises (D) at least one selected from the group consisting of a polybasic organic acid and a polybasic organic acid derivative.

(16) The electric collector according to (15), wherein the component (D) is at least one selected from the group consisting of a polybasic organic acid having a valence of 3 or more and a derivative of a polybasic organic acid having a valence of 3 or more.

(17) The electric collector according to (15), wherein the component (D) is at least one selected from the group consisting of an aromatic polybasic carboxylic acid and an aromatic polybasic carboxylic acid derivative.

(18) The electric collector according to (15), wherein the component (D) is a polybasic organic acid anhydride.

(19) The electric collector according to any one of (10) to (18), wherein the electrically-conductive substrate is aluminum or copper.

(20) The electric collector according to any one of (10) to (19), wherein the component (A) is a mixed solvent comprising water and a primary or secondary monohydric alcohol having 1 to 4 carbon atoms.

(21) The electric collector according to any one of (10) to (20), wherein the component (B) is an electrically-conductive carbonaceous material.

(22) An electric collector comprising an electrically-conductive substrate, and an undercoat layer formed on one or both surfaces of the electrically-conductive substrate, wherein the undercoat layer is formed by applying the coating solution according to any one of (1) to (8).

(23) The electric collector according to (22), wherein a penetration resistance value measured at 25 deg C. is 100 milliohm or less.

(24) The electric collector according to any one of (10) to (23), wherein a penetration resistance value measured at 25 deg C. after storage under an environment of a relative humidity of 50% and a temperature of 25 deg C. for 300 hours is 150% or less of a penetration resistance value measured at 25 deg C. at the time of initiation of the storage.

(25) The electric collector according to any one of (10) to (24), wherein the amount of the component (B) comprised in the coating solution is from 40% by mass to 70% by mass based on the total mass of components other than the component (A) in the coating solution.

(26) A method for producing an electric collector, which comprises applying the coating solution according to any one of (1) to (9) on one or both surfaces of an electrically-conductive substrate, and then heating at a temperature of 100 deg C. to 300 deg C.

(27) An electrode comprising the electric collector according to any one of (10) to

(25), and an electrode active material layer formed on an undercoat layer of the electric collector.

(28) An electrochemical device comprising the electrode according to (27).

(29) A power supply system comprising the electrochemical device according to (28).

### Advantageous Effects of Invention

The coating solution according to the present invention is suited for the formation of an undercoat layer, which is contributable to cost reduction and environmental burden reduction, and is also capable of providing an electrochemical device having low internal resistance, low impedance and high capacitance retention ratio.

The electric collector according to the present invention can be produced at low cost and is excellent in a penetration resistance value and moisture resistance, and is also capable of providing an electrochemical device having low internal resistance and low impedance at low cost. The electric collector according to the present invention is capable of obtaining an electrochemical device having low internal resistance, low impedance and high capacitance retention ratio even when used after storage under high humidity over a long time.

### DESCRIPTION OF EMBODIMENTS

The electric collector according to the present invention comprises an electrically-conductive substrate, and an undercoat layer formed on one or both surfaces of the electrically-conductive substrate.

The undercoat layer is formed by applying a coating solution comprising (A) water or a mixed solvent of water and an organic solvent, and (B) an electrical conducting material.

(Component (A): Water or Mixed Solvent of Water and Organic Solvent)

The component (A) used in the coating solution is water or a mixed solvent of water and an organic solvent. Among these, a mixed solvent of water and an organic solvent is preferred.

The organic solvent used in the component (A) is preferably an organic solvent which is compatible with water and exhibits an evaporation rate upon heating comparable with that of water, and also exhibits low environmental burdens. Specific examples thereof include primary or secondary monohydric alcohols having 1 to 4 carbon atoms such as methanol, ethanol, isopropyl alcohol, n-butanol and isobutanol; ethers having 3 or 4 carbon atoms such as methoxyethanol, dimethoxyethane, tetrahydrofuran and 1,4-dioxane; ketones having 3 or 4 carbon atoms such as acetone and methyl ethyl ketone; and the like. Among these organic solvents, primary or secondary monohydric alcohols having 1 to 4 carbon atoms are preferred, and isopropyl alcohol is more preferred. These organic solvents can be used alone or in combination of two or more.

The upper limit of the amount of an organic solvent used is preferably 50% by mass, more preferably 45% by mass, still more preferably 40% by mass, and most preferably 30% by mass, in the mixed solvent of water and an organic solvent. The lower limit of the amount, at which the effect of the use of the organic solvent is exerted, is preferably 1% by mass, more preferably 3% by mass, and still more preferably 6% by mass, in the mixed solvent of water and an organic solvent.

(Component (B): Electrical Conducting Material)

The component (B) used in the coating solution is an electrical conducting material.

The electrical conducting material used as the component (B) is preferably one comprising carbon as a main constituent component, namely, an electrically-conductive carbonaceous material.

The electrically-conductive carbonaceous material suitably includes acetylene black, ketjen black, carbon fibril, carbon nano-tube, carbon nanofiber, graphite or the like. These electrically-conductive carbonaceous materials can be used alone or in combination of two or more.

Examples of the electrical conducting material other than the electrically-conductive carbonaceous material include powders of metals such as gold, silver, copper, nickel, aluminum, and the like.

The electrical conducting material may be a particle having a spherical shape, an irregular shape or the like, or a particle having an anisotropic shape such as a needle shape or a rod shape.

There is no particular limitation on the particle size of the particle-shaped electrical conducting material, and the average primary particle diameter on a volume basis is preferably from 10 nm to 50 micrometer, and more preferably from 10 nm to 100 nm.

Since the anisotropic-shaped electrical conducting material has comparatively large surface area per weight, electrical conductivity can be increased by an increase in a contact area even when used in a small amount. Examples of particularly effective anisotropic-shaped electrically-conductive material include a carbon nano-tube and a carbon nanofiber. From the viewpoint of an improvement in electrical conductivity, the carbon nano-tube and the carbon nanofiber is preferably from 0.001 micrometer to 0.5 micrometer and more preferably from 0.003 micrometer to 0.2 micrometer in a fiber diameter, and is preferably from 1 micrometer to 100 micrometer and more preferably from 1 micrometer to 30 micrometer in a fiber length. Sizes such as an average particle diameter, a fiber diameter and a fiber length of the electrical conducting material can be obtained by measuring dimensions of a predetermined number of electrical conducting material particles using an electronic microscope, and averaging the measured values.

Moreover, the electrical conducting material is preferably 0.5 ohm cm or less in powder electric resistance as measured according to JIS K1469.

(Component (C): Binder)

It is preferred that the coating solution further comprises a binder as a component (C). The binder is not particularly limited as long as it is capable of mutually binding electrical conducting materials, or an electrical conducting material and an electrically-conductive substrate or an electrode active material layer. In the present invention, polysaccharides or polysaccharide derivatives are preferably used as the binder. Use of polysaccharides or polysaccharide derivatives enables an increase in an ion-permeability, electrolytic solution-resistance and tight adhesion between an electrical conducting material and an electrically-conductive substrate or an electrode active material layer, and also enables a decreased in a penetration resistance value of an electric collector.

Polysaccharides are polymer compounds in which a lot of monosaccharides or monosaccharide derivatives are polymerized by glycosidic bond. Usually, polymers composed of 10 or more monosaccharides or monosaccharide derivatives refer to polysaccharides, and polymers composed of less than 10 monosaccharides or monosaccharide derivatives can also be used. The polysaccharides may be either homopolysaccarides or heteropolysaccarides.

Monosaccharides constituting polysaccharides may be, in addition to conventional monosaccharides having only a hydroxyl group such as glucose, monosaccharides having a carboxyl group such as uronic acid, or monosaccharides having an amino group or an acetylamino group, i.e. amino sugar.

Specific examples of polysaccharides include agarose, amylose, amylopectin, alginic acid, inulin, carrageenan, chitin, glycogen, glucomannan, keratan sulfate, colominic acid, chondroitin sulfate, cellulose, dextran, starch, hyaluronic acid, pectin, pectic acid, heparan sulfate, levan, lentinan, chitosan, pullulan and curdlan.

Examples of the polysaccharide derivatives include hydroxyalkylated polysaccharides, carboxyalkylated polysaccharides, sulfate esterified polysaccharides and the like. From the viewpoint of high solubility in water, hydroxyalkylated polysaccharides are preferred, and glycerylated polysaccharides are more preferred. Hydroxyalkylated polysaccharides can be produced by a known method.

Among these, from the viewpoint of high ion permeability, chitin, chitosan, cellulose and a derivative thereof are preferred, hydroxyalkyl chitin, hydroxyalkyl chitosan and hydroxyalkyl cellulose are more preferred, hydroxyalkyl chitosan is still more preferred, and glycerylated chitosan is most preferred.

Examples of the binder other than polysaccharides and polysaccharide derivatives include polyvinylidene fluoride, ethylene-propylene-diene copolymer, acrylic acid ester polymer, acrylic acid ester-styrene copolymer and the like.

The binder is preferably from 10,000 to 200,000, and more preferably from 50,000 to 200,000 in weight average molecular weight. When the molecular weight is within this range, the electrical conducting material has good dispersibility, and coatability of the coating solution and strength of an undercoat layer are excellent. The molecular weight can be determined in terms of a standard sample such as polystyrene or pullulan by the measurement using gel permeation chromatography.

(Component (D): Polybasic Organic Acid and Polybasic Organic Acid Derivative)

It is preferred that the coating solution further comprises, as a component (D), at least one selected from the group consisting of a polybasic organic acid and a polybasic organic acid derivative. The polybasic organic acid or the polybasic organic acid derivative is not particularly limited as long as it allows polysaccharides to undergo crosslinking, and those which allow polysaccharides to undergo crosslinking through a thermal reaction are preferred. The polybasic organic acid and the polybasic organic acid derivative is preferably from 100 deg C. to 300 deg C., more preferably from 120 deg C. to 250 deg C., and still more preferably from 155 deg C. to 220 deg C. in temperature at which a crosslinking reaction arises. When the temperature is lower than 100 deg C., the crosslinking reaction may proceed too fast to control. In contrast, if the temperature is higher than 300 deg C., polysaccharides comprised in the coating solution may be decomposed. It is preferred that the polybasic organic acid or the polybasic organic acid derivative has a valence of 3 or more from the viewpoint of high crosslinking effect. Examples of the polybasic organic acid derivative include a polybasic organic acid ester, a polybasic organic acid anhydride and the like. Since the crosslinking reaction easily proceeds and causes fewer by-products, a polybasic organic acid anhydride is preferred.

The polybasic organic acid or the polybasic organic acid derivative is preferably an aromatic polybasic carboxylic acid, an alicyclic polybasic carboxylic acid and a derivative thereof, and more preferably an aromatic polybasic carboxylic acid and a derivative thereof, from the viewpoint of excellent thermostability of an undercoat layer. The polybasic organic acid or the polybasic organic acid derivative is preferably a chain aliphatic polybasic carboxylic acid and a derivative thereof from the viewpoint of solubility in water.

Examples of the aromatic polybasic carboxylic acid include aromatic dibasic carboxylic acids such as phthalic acid, isophthalic acid, terephthalic acid and the like; and aromatic tribasic or higher polybasic carboxylic acids such as trimellitic acid, pyromellitic acid and the like.

Examples of the aromatic polybasic carboxylic acid derivative include aromatic dibasic carboxylic acid derivatives such as dimethyl phthalate, diethyl phthalate, dimethyl isophthalate, dimethyl terephthalate, diethyl terephthalate, phthalic anhydride and the like; and aromatic tribasic or higher polybasic carboxylic acid derivatives such as trimethyl trimellitate, trimellitic anhydride, pyromellitic anhydride, 3,3′,4,4′-biphenyltetracarboxylic anhydride, 3,3′,4,4′-benzophenonetetracarboxylic anhydride, and the like.

Examples of the alicyclic polybasic carboxylic acid include alicyclic dibasic carboxylic acids such as tetrahydrophthalic acid, hexahydrophthalic acid, and the like; and alicyclic tribasic or higher polybasic carboxylic acids such as cyclohexane-1,2,4-tricarboxylic acid, cyclohexane-1,2,4,5-tetracarboxylic acid, and the like.

Examples of the alicyclic polybasic carboxylic acid derivative include alicyclic dibasic carboxylic acid derivatives such as tetrahydrophthalic anhydride, hexahydrophthalic anhydride, methyltetrahydrophthalic anhydride, methylhexahydrophthalic anhydride, methylnadic anhydride, hydrogenated methylnadic anhydride, trialkyltetrahydrophthalic anhydride and the like; and alicyclic tribasic or higher polybasic carboxylic acid derivatives such as 1,2,4-cyclohexanetricarboxylic anhydride, 1,2,4,5-cyclohexanetetracarboxylic anhydride and the like.

Examples of the chain aliphatic polybasic carboxylic acid include chain aliphatic dibasic carboxylic acids such as succinic acid, maleic acid, tartaric acid, malic acid, glutaric acid, itaconic acid, adipic acid and the like; and chain aliphatic tribasic or higher polybasic carboxylic acid such as citric acid, 1,2,3,4-butanetetracarboxylic acid and the like.

Examples of the chain aliphatic polybasic carboxylic acid derivative include chain aliphatic dibasic carboxylic acid derivatives such as succinic anhydride, dimethyl succinate, maleic anhydride, itaconic anhydride and the like; and chain aliphatic tribasic or higher polybasic carboxylic acid derivative such as trimethyl citrate and the like.

Among these, from the viewpoint of heat resistance of an undercoat layer, trimellitic anhydride or pyromellitic anhydride is preferably used, and pyromellitic anhydride is particularly preferably used. From the viewpoint of solubility in water, 1,2,3,4-butanetetracarboxylic acid is preferred.

These polybasic organic acids and polybasic organic acid derivatives can be used alone or in combination of two or more.

(Coating Solution)

The amount of the component (A) comprised in the coating solution is preferably from 20% by mass to 99% by mass, more preferably from 50% by mass to 98% by mass, and still more preferably from 80% by mass to 95% by mass, based on 100% by mass of the total mass of the coating solution. By adjusting the amount of the component (A) within the above range, the obtained coating solution has a moderate viscosity and is excellent in workability of coating or the like, and the coating amount of the coating solution can be adjusted to a suitable amount.

The amount of the component (B) comprised in the coating solution is preferably from 40% by mass to 70% by mass, and more preferably from 50% by mass to 70% by mass, based on 100% by mass of the total mass of components other than the component (A) in the coating solution. By adjusting the amount of the component (B) within the above range, the electrical conducting material is uniformly dispersed in the coating solution, and the electrical conducting material and the undercoat layer are less likely to come off from the electrically-conductive substrate, and thus an electric collector having good penetration resistance value and moisture resistance can be obtained.

In the coating solution according to the present invention, mass W_{B} of the component (B), mass W_{C} of the component (C), and mass W_{D} of the component (D) comprised therein preferably satisfy a relationship of 0.5≦W_{B}/(W_{C}+W_{D})≦5, more preferably satisfy a relationship of 0.6≦W_{B}/(W_{C}+W_{D})≦3, and still more preferably satisfy a relationship of 0.9≦W_{B}/(W_{C}+W_{D})≦2.

By adjusting W_{B}/(W_{C}+W_{D}) within the above range, the electrical conducting material is uniformly dispersed in the coating solution, and the electrical conducting material and the undercoat layer are less likely to come off from the electrically-conductive substrate, and thus an electric collector having good penetration resistance value and moisture resistance can be obtained. W_{D} may be zero.

When the coating solution comprises a component (C) and a component (D), mass W_{C} of the component (C) and mass W_{D} of the component (D) preferably satisfy a relationship of 0.8≦W_{C}/W_{D}≦5, more preferably satisfy a relationship of 1≦W_{C}/W_{D}≦3, and still more preferably satisfy a relationship of 1.1≦W_{C}/W_{D}≦2.5.

By adjusting W_{C}/W_{D} within the above range, dispersibility of polysaccharides in the coating solution can be improved, and mechanical strength, moisture resistance and electrolytic solution resistance of an undercoat layer can be improved.

In the coating solution according to the present invention, a viscosity at a normal temperature is preferably from 100 mPa s to 50,000 mPa s, more preferably from 100 mPa s to 10,000 mPa s, and still more preferably from 100 mPa s to 5,000 mPa s. The viscosity is measured by using a B type viscometer, with a rotor and a rotation speed suited for the viscosity range to be measured, For example, when the viscosity of about several hundreds mPa s of the coating solution is measured, the rotor and the rotation speed are respectively a speed rotor No. 2 and 60 rpm.

The coating solution may comprises, in addition to the above components (A) to (D), additives such as a dispersion stabilizer, a thickener, an antisettling agent, an anti-skinning agent, a defoamer, an electrostatic coatability modifier, an antisagging agent, a leveling agent, a crosslinking catalyst, a shedding inhibitor and the like. It is possible to use, as any of these additives, known additives. With respect to the additive amount, the total amount of additives is preferably 10 parts by mass or less based on 100 parts by mass of the total amount of components other than the component (A) in the coating solution.

(Preparation of Coating Solution)

The coating solution can be prepared by mixing a component (A), a component (B), and a component (C), and a component (D) and the above additives which are optionally added, using a mixer or the like. From the viewpoint of ease of preparation of a uniform coating solution, it is preferred that, first, a solution in which a component (A), a component (C), a component (D) and desired additives are mixed is prepared, and then the obtained solution is added to a component (B), followed by mixing. Examples of the mixer include a ball mill, a sand mill, a pigment disperser, a Raikai mixer, an ultrasonic disperser, a homogenizer, a planetary mixer, a Hobart mixer and the like.

(Electric Collector)

The electric collector according to the present invention is obtained by applying the above coating solution on an electrically-conductive substrate to form an undercoat layer.

The electrically-conductive substrate includes not only a substrate without holes, but also a perforated substrate such as a punching metal foil or a woven wire. The electrically-conductive substrate may be a substrate having a smooth surface, and a substrate having a surface roughened by an electrical or chemical etching treatment, namely, an etching foil is also suitable.

There is no particular limitation on thickness of the electrically-conductive substrate and, the thickness is preferably from 5 micrometer to 200 micrometer. By adjusting the thickness within this range, the occupancy of the electric collector in a predetermined volume of an electrochemical device or the like can be lowered and performances of an electrochemical device or the like per volume can be improved, and also it is possible to ensure the strength enough to handle the electrically-conductive substrate, electric collector or electrode.

Examples of the material of the electrically-conductive substrate include a metal foil, an electrically-conductive resin film and the like which are known as an electrode substrate of an electrochemical device. Examples of the material of preferred electrically-conductive substrate include an aluminum foil, a copper foil and the like. As the aluminum foil, for example, a foil made of an A1085 material, an A3003 material or the like is usually used. As the copper foil, for example, a rolled copper foil and an electrolytic copper foil are usually used.

There is no particular limitation on the method of applying a coating solution on an electrically-conductive substrate, and a known coating method, which is used in the production of an undercoat layer used in a lithium ion battery, an electric double-layer capacitor or the like, can be employed as it is.

Specific examples thereof include a casting method, a bar coater method, a dipping method, a printing method and the like. Among these methods, from the viewpoint of ease of control of a thickness of a coating film, a bar coating method, a gravure coating method, a gravure reverse coating method, a roll coating method, a mayer bar coating method, a blade coating method, a knife coating method, an air knife coating method, a comma coating method, a slot die coating method, a slide die coating method and a dip coating method are preferred.

A portion of the electrically-conductive substrate may be coated, or the entire surface thereof may be coated. When a portion of the electrically-conductive substrate is coated, a portion other than a peripheral portion of the electrically-conductive substrate may be coated all over, or may be coated in a grid-shaped pattern, a lattice-shaped pattern, a dot-shaped pattern or the like. One or both surfaces of the electrically-conductive substrate may be coated. When both surfaces are coated, each one surface may be separately coated, or both surfaces may be simultaneously coated.

The amount of the coating solution applied to the electrically-conductive substrate is preferably from 0.2 g/m² to 5 g/m², more preferably from 0.5 g/m² to 3 g/m², and most preferably from 1 g/m² to 2 g/m², in terms of the weight after drying. The amount of the coating solution within the above range is effective for reduction in internal resistance and impedance.

After applying the coating solution, the coating solution is preferably dried. There is no particular limitation on the drying method, and it is preferred to heat at a temperature at which a crosslinking reaction of polysaccharides arises, preferably within a range from 100 deg C. to 300 deg C., more preferably from 120 deg C. to 250 deg C., and still more preferably from 155 deg C. to 220 deg C., for 10 seconds to 10 minutes. By heating under the above conditions, it is possible to suppress water from remaining in an undercoat layer and components in the coating solution from decomposing while maintaining productivity, and to reduce roughness of a surface of the undercoat layer.

The thickness of the undercoat layer is preferably from 0.01 micrometer to 50 micrometer, and more preferably from 0.1 micrometer to 10 micrometer. By adjusting the thickness within the above range, internal resistance and impedance can be reduced in a thin-type electric collector which is advantageous for miniaturization of an electrochemical device or the like.

(Penetration Resistance Value)

The penetration resistance value at 25 deg C. of the electric collector according to the present invention is preferably 100 milliohm or less, more preferably 80 milliohm or less, and still more preferably 60 milliohm or less.

The penetration resistance value of the electric collector is measured in the following manner. An electric collector comprising an electrically-conductive substrate and an undercoat layer is cut into two strips, each measuring 20 mm in width and 100 mm in length. These strips are laid one upon another in a state where undercoat layers face to each other so that a contact face becomes a rectangular shape measuring 20 mm and 20 mm, and then placed on a vinyl chloride resin plate. They are fixed by applying a load of 1 kg/cm² to the portion where two strips are contacted each other. Each end portion where electric collectors are not contacted each other is connected to an AC milliohm meter and then penetration resistance is measured. This measured value is regarded as a penetration resistance value.

Moisture resistance of an electric collector is evaluated in the following manner. First, an electric collector comprising an electrically-conductive substrate and an undercoat layer is cut into a size measuring 300 mm and 300 mm.

Herein, it is preferred to use, as the electric collector, an electric collector immediately after production, an electric collector exposed to the environment with a relative humidity of 10% or more for less than 60 minutes after production, or an electric collector stored in a dry room or a vacuum container with a relative humidity of less than 10%, or a sealed container such as an aluminum laminated package sealed with desiccant immediately after production.

Four strip-shaped samples, each measuring 20 mm in width and 100 mm in length, are cut out from the cut electric collector.

With respect to two samples among samples thus cut out, a penetration resistance value is immediately measured. This measured value is regarded as an initial resistance value. The remaining two samples are placed in a constant temperature and constant humidity chamber under the atmosphere at a temperature of 25 deg C. and a relative humidity of 50%. After a lapse of 300 hours, the electric collector is taken out from the constant temperature and constant humidity chamber and a penetration resistance value is immediately measured. A comparison with the initial resistance value is made. After a lapse of 300 hours, the penetration resistance value is preferably 150% or less, more preferably 130% or less, and most preferably 120% or less, assuming that the initial resistance value is 100%.

(Electrode)

The electrode according to the present invention comprises an electric collector of the present invention, and an electrode active material layer formed on an undercoat layer of the electric collector.

The electrode active material layer can be formed using a known material and a known method which is used in the production of a lithium ion secondary battery, an electric double layer capacitor, a hybrid capacitor and the like.

The electric collector according to the present invention can be also used in an electrode of electrochemical devices other than a lithium ion secondary battery, an electric double layer capacitor and a hybrid capacitor. Moreover, the electric collector according to the present invention can be used in an electrode of a solar battery and a touch panel.

(Electrochemical Device)

The electrochemical device according to the present invention comprises an electrode of the present invention, and also usually comprises a separator and an electrolytic solution. With respect to the electrode in the electrochemical device, both a positive electrode and a negative electrode may be electrodes according to the present invention, or either one may be the electrode according to the present invention and the other one is an electrode other than that of the present invention. In the lithium ion battery, at least a positive electrode is preferably the electrode according to the present invention. The separator and electrolytic solution are not particularly limited as long as they are used in secondary batteries such as a lithium ion battery and the like, an electric double layer capacitor, a hybrid capacitor and the like.

The electrochemical device according to the present invention can be applied to a power supply system. This power supply system can be applied to automobiles; transportation equipments such as a railroad, a ship and an aircraft; portable equipment such as a portable phone, a personal digital assistant or a portable electronic calculator; business equipment; power generating systems such as a solar power generating system, a wind power generating system and a fuel cell system; and the like.

The present invention will be described more specifically by way of Examples and Comparative Examples. The scope of the present invention is not limited by these Examples. The present invention can be practiced by appropriately modifying the coating solution, the electric collector, the electrode, the electrochemical device and the power supply system according to the present invention without departing from the scope of the present invention.

(Preparation of Coating Solution)

### Examples 1 to 6 and Comparative Examples 1 to 3

Components (A), (C) and (D) shown in Table 1 were mixed and the obtained mixture was added to a component (B) shown in Table 1, followed by stirring using a dissolver type stirrer at 300 rpm for 10 minutes to obtain coating solutions 1 to 9.

TABLE 1

| | Examples | | | | | | Comp. Ex. | | |
|---|---|---|---|---|---|---|---|---|---|
| | 1 | 2 | 3 | 4 | 5 | 6 | 1 | 2 | 3 |
| Coating solution No. | 1 | 2 | 3 | 4 | 5 | 6 | 7 | 8 | 9 |
| Component (A) | | | | | | | | | |
| Ion exchanged water | 125 | 113 | 99 | 99 | 125 | 99 | 155 | | 116 |
| [Parts by mass] | | | | | | | | | |
| Isopropyl alcohol^{a)} | 17 | 15 | 14 | 14 | 17 | 14 | 21 | 31 | 16 |
| [Parts by mass] | | | | | | | | | |
| N-methyl pyrrolidone^{b)} | | | | | | | | 145 | |
| [Parts by mass] | | | | | | | | | |
| Component (B) | | | | | | | | | |
| Acetylene black^{c)} | 10 | 10 | 10 | 10 | 10 | 15 | 10 | 10 | 20 |
| [Parts by mass] | | | | | | | | | |
| Component (C) | | | | | | | | | |
| Glycerylated chitosan^{d)} | 10 | 6.7 | 6.7 | 5 | 10 | 2.5 | 11 | 11 | 2.2 |
| [Parts by mass] | | | | | | | | | |
| Component (D) | | | | | | | | | |
| Pyromellitic | 5 | 6.7 | 3.4 | 5 | | | 10 | 10 | 1.1 |
| anhydride^{e)} | | | | | | | | | |
| [Parts by mass] | | | | | | | | | |
| Butanetetracarboxylic | | | | | 5 | 2.5 | | | |
| acid^{f)} [Parts by mass] | | | | | | | | | |
| Concentration of | 12% | 12% | 12% | 12% | 12% | 12% | 12% | 100% | 12% |
| organic solvent | | | | | | | | | |
| in component (A) | | | | | | | | | |
| [% by mass] | | | | | | | | | |
| Concentration of | | | | | | | | | |
| component (A) | 85% | 85% | 85% | 85% | 85% | 85% | 85% | 85% | 85% |
| in coating solution | | | | | | | | | |
| [% by mass] | | | | | | | | | |
| W_{B}/(W_{B} + W_{C} + W_{D}) × 100 | 40% | 43% | 50% | 50% | 40% | 75% | 32% | 32% | 86% |
| [% by mass] | | | | | | | | | |
| W_{B}/(W_{C} + W_{D}) | 0.67 | 0.75 | 0.99 | 1.00 | 0.67 | 3.00 | 0.48 | 0.48 | 6.06 |
| W_{C}/W_{D} | 2.0 | 1.0 | 2.0 | 1.0 | 2.0 | 1.0 | 1.1 | 1.1 | 2.0 |
| Viscosity (mPa · s) | 168 | 172 | 166 | 183 | 185 | 222 | 173 | 1502 | 160 |

^{a)}Commercially available product (Industrial Grade)
^{b)}Commercially available product (Industrial Grade)
^{c)}Manufactured by Denki Kagaku Kogyo Kabushiki Kaisha under the trade name of DENKA BLACK (powdered product) Electric resistance according to JIS K1469 is 0.20 Ω · cm. Average particle diameter is 35 nm
^{d)}Glycerylated chitosan having an acetylation degree of 14 mol %, a glycerylation degree of 50 mol % and a weight average molecular weight (in terms of pulluian) of 8.64 × 10⁴ synthesized by a known method was used.
^{e)}Commercially available product (Guaranteed Reagent)
^{f)}Manufactured by New Japan Chemical Co., Ltd. under the trade name of RIKACID BT-W

(Production and Evaluation of Electric Collector)

### Examples 7 to 12 and Comparative Examples 4 to 6

An alkali washed aluminum foil made of an A1085 material having a thickness of 30 micrometer was prepared. Using an applicator, coating solutions 1 to 9 were respectively applied on both surfaces of the aluminum foil by a cast method so that a coating amount after drying was 0.5 g/m². They were dried with heating at 180 deg C. for 3 minutes to obtain electric collectors 1A to 9A. The electric collectors 1A to 8A were stored in a container with a relative humidity of less than 10% after production so that the time of exposure to the environment with a relative humidity of 10% or more is less than 30 minutes.

Each of the obtained electric collectors 1A to 9A was cut into two sheets, each measuring 20 mm in width and 100 mm in length. The coated surfaces of the obtained two sheets were allowed to face to each other and adjustment was made so that a contact face become a shape measuring 20 mm and 20 mm, and then the sheets were placed on a vinyl chloride resin plate. They were fixed by applying a load of 1 kg/cm² to the portion where two sheets were contacted each other. Each end portion where electric collectors were not contacted each other was connected to an AC milliohm meter and then penetration resistance was measured. This measured value was regarded as a penetration resistance value (initial value). Since an electrical conducting material was peeled off in the electric collector 9A, it was impossible to measure a penetration resistance value.

The electric collectors 1A to 8A were stored in a constant temperature and constant humidity chamber (manufactured by ESPEC Corp.) under the atmosphere of 25 deg C. and a relative humidity of 50% for 300 hours. After storage, electric collectors 1B to 8B were taken out and a penetration resistance value was immediately measured. After a lapse of 300 hours, an index of the penetration resistance value was calculated assuming that the initial value was 100%.

The results are shown in Table 2. The electric collectors 1A to 6A obtained using the coating solution of the present invention show a low penetration resistance value (initial value) when compared with the electric collector 8A produced using a non-aqueous coating solution. After storage under high humidity for 300 hours, the electric collectors 1B to 6B show a low penetration resistance value when compared with the electric collector 8B.

TABLE 2

| | Examples | | | | | | Comp. Ex. | | |
|---|---|---|---|---|---|---|---|---|---|
| | 7 | 8 | 9 | 10 | 11 | 12 | 4 | 5 | 6 |
| Coating | 1 | 2 | 3 | 4 | 5 | 6 | 7 | 8 | 9 |
| solution No. | | | | | | | | | |
| Electric | 1A | 2A | 3A | 4A | 5A | 6A | 7A | 8A | 9A |
| collector No. | | | | | | | | | |
| immediately | | | | | | | | | |
| after | | | | | | | | | |
| production | | | | | | | | | |
| Penetration | | | | | | | | | |
| resistance | | | | | | | | | |
| value | | | | | | | | | |
| Initial | 83 | 66 | 61 | 63 | 85 | 52 | 125 | 101 | — |
| value [mΩ] | | | | | | | | | |
| Electric | 1B | 2B | 3B | 4B | 5B | 6B | 7B | 8B | — |
| collector No. | | | | | | | | | |
| after storage | | | | | | | | | |
| for 300 hours | | | | | | | | | |
| Penetration | | | | | | | | | |
| resistance | | | | | | | | | |
| value | | | | | | | | | |
| After 300 | 113 | 88 | 76 | 76 | 113 | 58 | 371 | 176 | — |
| hours [mΩ] | | | | | | | | | |
| [After 300 | 136% | 134% | 124% | 121% | 133% | 111% | 297% | 174% | — |
| hours/Initial | | | | | | | | | |
| value] × 100 | | | | | | | | | |

A penetration resistance value could not be measured since an electrical conducting material of an electric collector 9A was peeled off.

(Production and Evaluation of Lithium-Ion Battery)

### Examples 13 to 18 and Comparative Examples 7 to 8

Each of the electric collectors 1A to 8A was cut into a size measuring 10 cm and 10 cm. A slurry obtained by mixing 95 parts by mass of lithium cobaltate (manufactured by Nippon Chemical Industrial Co., Ltd. under the trade name of CELLSEED C), 2 parts by mass of acetylene black (manufactured by Denki Kagaku Kogyo Kabushiki Kaisha under the trade name of DENKA BLACK (powdered product)), 3 parts by mass of polyvinylidene fluoride (manufactured by Kureha Corporation under the trade name of KF polymer #1120) and 95 parts by mass of N-methyl-2-pyrrolidone (Industrial Grade) was applied on both surfaces of each electric collector. It was dried and pressed to form a positive electrode active material layer with one surface having a thickness of 50 micrometer. This layer was used as a positive electrode.

On both surfaces of a 10 micrometer thick electrolytic copper foil, a slurry obtained by mixing 94 parts by mass of artificial graphite (manufactured by Showa Denko K.K. under the trade name of SCMG-AR), 1 part by mass of acetylene black (manufactured by Denki Kagaku Kogyo Kabushiki Kaisha under the trade name of DENKA BLACK (powdered product)), 5 parts by mass of poylvinylidene fluoride (manufactured by Kureha Corporation under the trade name of KF polymer #9130) and 94 parts by mass of N-methyl-2-pyrrolidone (Industrial Grade) was applied. It was dried and pressed to form a negative electrode active material layer with one surface having a thickness of 55 micrometer. This layer was used as a negative electrode.

A separator (manufactured by POLYPORE International, Inc. under the trade name of Celgard 2500) was incorporated into the positive electrode and the negative electrode, and the obtained laminates were alternately laminated in the number required to a design capacitance of 1 Ah, and then an aluminum tab was attached to the positive electrode and a nickel tab was attached to the negative electrode respectively by ultrasonic welding machine. These were placed in a bag-shaped aluminum laminated packing material, and moisture was removed by a vacuum dryer at 60 deg C. Next, a LiPF₆ solution (manufactured by KISHIDA CHEMICAL Co., Ltd.) was injected as an organic electrolytic solution, followed by impregnation under a vacuum atmosphere for 24 hours. Thereafter, an opening of the aluminum laminated packing material was sealed by a vacuum sealer to obtain lithium ion secondary batteries 1A to 8A.

Lithium ion secondary batteries 1B to 8B were obtained by the same manner as described above except that the electric collectors 1A to 8A were replaced by electric collectors 1B to 8B.

The internal resistance of the obtained lithium ion secondary batteries was measured at a measuring frequency of 1 kHz by an AC impedance method, using an impedance meter (manufactured by HIOKI E.E. CORPORATION).

Cycle characteristics of the lithium ion secondary batteries were measured. In the measurement, charge and discharge were carried out using a charge and discharge device (manufactured by Toyo System Co., Ltd.) under the conditions of a current rate of 0.2 C, 2 C and 20 C, and then a capacitance after 200 cycles was measured. An index (capacitance retention ratio) of a capacitance at 2 C and 20 C after 200 cycles was calculated assuming that a capacitance at 0.2 C after 200 cycles is 100. The measurement was carried out at a cut voltage of 2.7 V to 4.2 V and SOC of 100%.

The results are shown in Table 3. The lithium ion secondary batteries produced by using the electric collector of the present invention show small internal resistance and are excellent in cycle characteristics. The electric collector of the present invention shows small internal resistance and is capable of producing a lithium ion secondary battery having excellent cycle characteristics even after storage under high humidity. Since an aqueous solvent is used in the production of the electric collector, a lithium ion secondary battery can be produced with low environmental burdens.

TABLE 3

| | Examples | | | | | | Comp. Ex. | |
|---|---|---|---|---|---|---|---|---|
| | 13 | 14 | 15 | 16 | 17 | 18 | 7 | 8 |
| Lithium ion battery No. | 1A | 2A | 3A | 4A | 5A | 6A | 7A | 8A |
| Electric collector No. | 1A | 2A | 3A | 4A | 5A | 6A | 7A | 8A |
| Internal resistance [mΩ] | 10 | 10 | 10 | 9 | 12 | 9 | 22 | 15 |
| Capacitance | | | | | | | | |
| retention ratio | | | | | | | | |
| 2C | 98 | 97 | 98 | 98 | 97 | 98 | 95 | 97 |
| 20C | 56 | 56 | 57 | 57 | 55 | 59 | 42 | 57 |
| Lithium ion battery No. | 1B | 2B | 3B | 4B | 5B | 6B | 7B | 8B |
| Electric collector No. | 1B | 2B | 3B | 4B | 5B | 6B | 7B | 8B |
| internal resistance [mΩ] | 15 | 15 | 15 | 13 | 18 | 12 | 57 | 23 |
| Capacitance | | | | | | | | |
| retention ratio | | | | | | | | |
| 2C | 96 | 96 | 96 | 97 | 95 | 97 | 91 | 96 |
| 20C | 51 | 52 | 51 | 53 | 51 | 53 | 33 | 52 |

(Production and Evaluation of Electric Double-Layer Capacitor)

### Examples 19 to 24 and Comparative Examples 9 to 10

On both surfaces of electric collectors 1A to 8A, a paste composed of 100 parts by mass of activated carbon (manufactured by KURARAY CHEMICAL CO., LTD. under the trade name of YP-50F), 5 parts by mass of acetylene black (manufactured by Denki Kagaku Kogyo Kabushiki Kaisha under the trade name of DENKA BLACK (powdered product)), 7.5 parts by mass of styrene-butadiene rubber (manufactured by NIPPON A&L INC. under the trade name of NALSTAR SR-103), 2 parts by mass of carboxymethyl cellulose (manufactured by DAICEL FINECHEM LTD. under the trade name of CMC DN-10L) and 200 parts by mass of pure water was applied, followed by drying and further pressing to form each electrode layer with one surface having a thickness of 80 micrometer. Each layer was used as an electrode for an electric double-layer capacitor.

Next, two electrodes for an electric double-layer capacitor, each having a diameter of 20 mm were punched out. Two electrodes were laid one upon another while interposing a separator (manufactured by NIPPON KODOSHI CORPORATION under the trade name of TF40) therebetween and the obtained laminate was accommodated in a capacitor container for evaluation. An organic electrolytic solution (manufactured by TOMIYAMA PURE CHEMICAL INDUSTRIES, LTD. under the trade name of LIPASTE-P/EAFIN (1 mol/liter)) was injected into the container and electrodes and the like were dipped and, finally, the container was covered with a lid to obtain electric double-layer capacitors for evaluation 1A to 8A.

Electric double-layer capacitors for evaluation 1B to 8B were obtained by the same manner as described above except that the electric collectors 1A to 8A were replaced by electric collectors 113 to 8B.

Impedance and electric capacitance of the obtained electric double-layer capacitors were measured. The impedance was measured using an impedance meter (manufactured by KIKUSUI ELECTRONICS CORP. under the trade name of PAN110-5AM) under the condition of 1 kHz. The electric capacitance was measured by charging and discharging using a charge and discharge tester (manufactured by HOKUTO DENKO CORPORATION under the trade name of HJ-101SM6) at a current density of 1.59 mA/cm² and 0 V to 2.5 V. From a discharge curve measured at the time of second discharge at a constant current, an electric capacitance (F/cell) per cell of an electric double-layer capacitor was calculated. A capacitance maintenance ratio (%) was calculated as (electric capacitance at the 50th cycle)/(electric capacitance at the 2nd cycle)*100.

TABLE 4

| | Examples | | | | | | Comp. Ex. | |
|---|---|---|---|---|---|---|---|---|
| | 19 | 20 | 21 | 22 | 23 | 24 | 9 | 10 |
| Electric double- | 1A | 2A | 3A | 4A | 5A | 6A | 7A | 8A |
| layer capacitor | | | | | | | | |
| No. | | | | | | | | |
| Electric | 1A | 2A | 3A | 4A | 5A | 6A | 7A | 8A |
| collector No. | | | | | | | | |
| Impedance [Ω] | 1.42 | 1.44 | 1.48 | 1.39 | 1.49 | 1.38 | 2.57 | 1.55 |
| Electric | 1.62 | 1.62 | 1.65 | 1.65 | 1.63 | 1.65 | 1.59 | 1.61 |
| capacitance [F] | | | | | | | | |
| Capacitance | 96% | 97% | 97% | 97% | 96% | 97% | 85% | 97% |
| maintenance ratio | | | | | | | | |
| Electric double- | 1B | 2B | 3B | 4B | 5B | 6B | 7B | 8B |
| layer capacitor | | | | | | | | |
| No. | | | | | | | | |
| Electric | 1B | 2B | 3B | 4B | 6B | 6B | 7B | 8B |
| collector No. | | | | | | | | |
| Impedance [Ω] | 2.13 | 2.11 | 2.13 | 2.05 | 2.16 | 1.98 | 5.89 | 2.08 |
| Electric | 1.58 | 1.58 | 1.56 | 1.58 | 1.59 | 1.61 | 1.54 | 1.59 |
| capacitance [F] | | | | | | | | |
| Capacitance | 92% | 91% | 92% | 93% | 92% | 93% | 70% | 92% |
| maintenance ratio | | | | | | | | |

The results are shown in Table 4. The electric double-layer capacitors produced by using the electric collector of the present invention show low impedance and are excellent in cycle characteristics. Since an aqueous solvent is used in the production of the electric collector, an electric double-layer capacitor can be produced with low environmental burdens.

1. A coating solution comprising
(A) water or a mixed solvent of water and an organic solvent,
(B) an electrical conducting material, and
(C) at least one selected from the group consisting of polysaccharides and polysaccharide derivatives as essential components, and
(D) at least one selected from the group consisting of a polybasic organic acid and a polybasic organic acid derivative as an optional component, wherein
mass W_{B} of the component (B), mass W_{C} of the component (C) and
mass W_{D} of the component (D) satisfy a relationship of 0.5≦W_{B}/(W_{C}+W_{D})≦5.

2. The coating solution according to claim 1, wherein the component (A) is a mixed solvent comprising water and a primary or secondary monohydric alcohol having 1 to 4 carbon atoms.

3. The coating solution according to claim 1, wherein the component (C) is at least one selected from the group consisting of chitin, chitosan, cellulose, cellulose derivative and chitosan derivative.

4. The coating solution according to claim 1, wherein the component (C) is hydroxyalkylated polysaccharides.

5. The coating solution according to claim 1, wherein the component (D) is at least one selected from the group consisting of a polybasic organic acid having a valence of 3 or more and a derivative of a polybasic organic acid having a valence of 3 or more.

6. The coating solution according to claim 1, wherein the component (D) is at least one selected from the group consisting of an aromatic polybasic carboxylic acid and an aromatic polybasic carboxylic acid derivative.

7. The coating solution according to claim 1, wherein the component (D) is a polybasic organic acid anhydride.

8. The coating solution according to claim 1, wherein the component (B) is an electrically-conductive carbonaceous material.

9. The coating solution according to claim 1, wherein the mass W_{C} of the component (C) and the mass W_{D} of the component (D) satisfy a relationship of 0.8≦W_{C}/W_{D}≦5.

10. An electric collector comprising an electrically-conductive substrate, and an undercoat layer formed on one or both surfaces of the electrically-conductive substrate, wherein
the undercoat layer is formed by applying a coating solution comprising:
(A) water or a mixed solvent of water and an organic solvent, and
(B) an electrical conducting material,
in which the electric collector is 100 milliohm or less in a penetration resistance value measured at 25 deg C.

11. The electric collector according to claim 10, wherein the coating solution further comprises (C) a binder.

12. The electric collector according to claim 11, wherein the component (C) is at least one selected from the group consisting of polysaccharides and polysaccharide derivatives.

13. The electric collector according to claim 10, wherein the coating solution further comprises (D) at least one selected from the group consisting of a polybasic organic acid and a polybasic organic acid derivative.

14. An electric collector comprising an electrically-conductive substrate, and an undercoat layer formed on one or both surfaces of the electrically-conductive substrate, wherein the undercoat layer is formed by applying the coating solution according to claim 1.

15. The electric collector according to claim 10, wherein a penetration resistance value measured at 25 deg C. after storage under an environment of a relative humidity of 50% and a temperature of 25 deg C. for 300 hours is 150% or less of a penetration resistance value measured at 25 deg C. at the time of initiation of the storage.

16. The electric collector according to claim 10, wherein the amount of the component (B) comprised in the coating solution is from 40% by mass to 70% by mass based on the total mass of components other than the component (A) in the coating solution.

17. A method for producing an electric collector, which comprises applying the coating solution according to claim 1 on one or both surfaces of an electrically-conductive substrate, and then heating at a temperature of 100 deg C. to 300 deg C.

18. An electrode comprising:
the electric collector according to claim 10, and
an electrode active material layer formed on the undercoat layer of the electric collector.

19. An electrochemical device comprising the electrode according to claim 18.

20. A power supply system comprising the electrochemical device according to claim 19.
